(19) United States
(12) Patent Application Publication
(10) Pub. No.: US 2009/0050265 A1
(43) Pub. Date: Feb. 26, 2009

(54) Apparatus for making a fishing line knot

(76) Inventor: Hirofusa Otsubo, Middle Village, NY (US)

Correspondence Address: Hirofusa Otsubo, 60-16 83rd Place, Middle Village, NY, 11379, US

(21) Appl. No.: 11/895,405

(22) Filed: Aug. 24, 2007

(51) Int. Cl. B29C 65/50; B32B 27/12

(52) U.S. Cl. 156/293; 428/375

(57) ABSTRACT

A method and apparatus for attaching a fishing line to a fishing hook is presented. The method includes steps of obtaining an amount of adhesive material, applying the adhesive material to an end portion of the fishing line, passing the end portion through a hook eye of the fishing hook and knotting the end portion in a manner such that the adhesive material substantially prevents slipping in the knot and substantially reduces slipping of the fishing line on the hook eye whereby breakage of the fishing line is substantially reduced during fishing.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to knots. More particularly, the invention relates to a method and device for making knots in a fishing line that generally prevents slippage in the knot and breakage of the fishing line.

### BACKGROUND OF THE INVENTION

In the field of fishing, an important area is fishing line connection by knot tying, especially at the line connection to the hook eye, where violent jolts occur as the fish struggles to free itself. Also, the connection to the hook eye is the key connecting point of fish and fisherman. FIG. 1 illustrates an exemplary conventional fishing hook 5 having a hook eye 6, in accordance with the prior art. Current knot connection techniques are susceptible to break off with strong pulls from a fish because of the line slip from the knots, not only at the knot at hook eye 6, but also all other knot connections. It is widely known in the art that it is preferable for the knotted section of the line to be in a tight, constant linear section. However, this section of the line has little flexibility, so, when the knot is subjected to strong fish pulls, the line making up the knot section begins to slip away, and as a result, the slipped line changes its original constant linear form into a curly irregular form. This line deformation is the main cause of line breakage in all of the knots. Moreover, conventional hook eyes, for example, without limitation, hook eye 6, and fishing line knots are known to be susceptible to the fishing line knot becoming undone because of the hook eye's slippery steel surface. This fishing line slip also tends to creates fatigue leading to breakage by thinning the fishing line at the slipping contact point.

A common misunderstanding about fishing line strength is that a line will not break below its rated breaking force. For example, without limitation, 50 LB line is design to break with a force of around 50 LB. Yet, this is not true in real field study because the knot sections of the line create weak points in the line. The line slip from the knot is the main cause of line break, reducing the strength of the line to about 20% less than the full capacity of the line.

In view of the foregoing, there is a need for an improved method and device for making knots in fishing line that generally prevent slipping in the line and against the hook eye, and against other knot sections, the overall strength of the line connections.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary conventional fishing hook having a hook eye, in accordance with the prior art;

FIG. 2 is a perspective view of an exemplary plastic floss container for exemplary sticky floss, in accordance with an embodiment of the present invention;

FIG. 3 is a perspective view of an exemplary roll of floss coated with glue to be stored inside a floss container as shown by way of example in FIG. 2, in accordance with an embodiment of the present invention; and

FIGS. 4(a), 4(b), and 4(c) are front views of exemplary stages of tying a knot in a fishing line with floss, in accordance with an embodiment of the present invention.

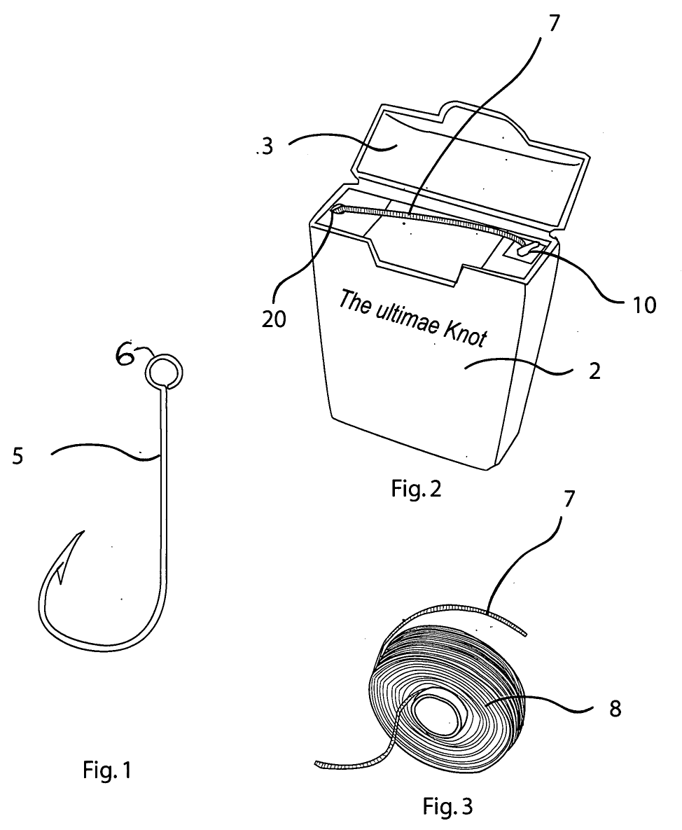

Unless otherwise indicated illustrations in the figures are not necessarily drawn to scale.

### SUMMARY OF THE INVENTION

To achieve the forgoing and other objects and in accordance with the purpose of the invention, a method and apparatus for making a fishing line knot is presented.

In one embodiment, a method of attaching a fishing line to a fishing hook is presented. The method includes steps of obtaining an amount of adhesive material, applying the adhesive material to an end portion of the fishing line, passing the end portion through a hook eye of the fishing hook and knotting the end portion in a manner such that the adhesive material substantially prevents slipping in the knot and substantially reduces slipping of the fishing line on the hook eye whereby breakage of the fishing line is substantially reduced during fishing. In another embodiment, the adhesive material includes a floss material coated with an adhesive. Other embodiments include the steps of obtaining further includes steps of dispensing a portion of the floss material from a container, the steps of obtaining further includes steps for cutting the portion and the steps of applying further includes steps of orienting the portion of floss material parallel to the end portion of the fishing line. Further embodiments include the steps of applying further includes steps of wrapping the floss material about the end portion, the steps of applying further includes steps of rubbing the adhesive material onto the end portion and the steps of applying further includes steps of spraying the adhesive material onto the end portion.

In another embodiment an apparatus for making a fishing line knot is presented. The apparatus including a quantity of floss material coated with an adhesive and dispensing means for dispensing a portion of floss material to be placed on an end portion of the fishing line where the floss material substantially prevents slipping in the knot. In another embodiment the dispensing means further includes means for cutting the portion of floss material from the quantity of floss material. In yet other embodiments the floss is waxed, the floss material is generally flat, a width of the floss material is less than a circumference of the fishing line and the floss material is coated with the adhesive on at least one side. In still other embodiments the floss material includes a plastic material, the floss material is colored to match a color of a fly or lure and the floss material is coated with a fish fragrance to enhance a lure being used.

In another embodiment an apparatus for making a fishing line knot is presented. The apparatus includes means for providing an adhesive and means for dispensing a portion of the adhesive to be placed on an end portion of the fishing line where the adhesive substantially prevents slipping in the knot. Another embodiment further includes means for providing a fish fragrance to the adhesive means. Yet another embodiment further includes means for providing a coloring to the adhesive means.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

In order to prevent line deformation by slippage, the preferred embodiment of the present invention provides a thin, plastic floss tape coated with an adhesive. The floss is designed to stick along with the fishing line in order to generally prevent line slippage from the knot section by providing a sticky surface to avoid slipping of the line against itself and a gentle shock absorber function to prevent line breakage from the knot section. Using embodiments of the present invention also generally prevents slipping line from the knot especially between the knot and the hook eye that may lead to thinning and breaking of the line by providing a sticky surface and providing extra thickness on the line at the hook eye connection. Also the present embodiment generally prevents slipping line from the knot connection from the other end of knotted fishing line. Testing has shown that when using embodiments of the present invention the line typically breaks off beyond the point of the line durability and no line breakage occurs from the knot section. It is also shown that the overall strength of the line knot connection is increased with the application of embodiments of the present invention.

FIG. 2 is a perspective view of an exemplary plastic floss container 2 for exemplary sticky floss 7, in accordance with an embodiment of the present invention. In the present embodiment, floss 7 is stored on a roll, shown by way of example in FIG. 3, inside a floss container 2. Floss 7 may be pulled out from a hole 20 and set at a line cut edge 10. Line cut edge 10 enables floss 7 to be cut to the length desired by the user. Floss container 2 is substantially box-shaped and comprises a lid 3 that snaps to close. In the present embodiment, floss container 2 and lid 3 are constructed of plastic.

In the present embodiment, floss 7 is waxed tape floss coated with an adhesive material. In the preferred embodiment, floss 7 is made of a plastic material; however, in alternate embodiments, the floss may be made of various other materials such as, but not limited to, natural thread materials such as silk, cotton, yarn, rubber and other artificial type thread materials such as plastic, nylon. In alternate embodiments, the floss may be un-waxed. In the present embodiment, floss 7 has adhesive on both sides; however, in alternate embodiments the floss may only have adhesive on the side to be applied to the fishing line. Preferably, floss 7 is equal in size or somewhat smaller that the fishing line to which floss 7 is being applied. In alternate embodiments, floss 7 may be larger than the fishing line so that floss 7 may be wrapped completely around the fishing line. In some embodiments, floss 7 may be colored, for example, without limitation, light blue, black, red, etc. to mach to the color of the water or the color of the fly or lure being used on the line. In some embodiments floss 7 may also be coated with a fish fragrance to enhance the lure being used.

FIG. 3 is a perspective view of an exemplary roll 8 of floss 7 coated with adhesive to be stored inside a floss container as shown by way of example in FIG. 2, in accordance with an embodiment of the present invention. In the present embodiment, roll 8 is designed to be stored horizontally inside of the floss container; however, alternate embodiments may use various other means for dispensing floss 7 such as, but not limited to, a floss container comprising a vertical spool. Some embodiments may not have a dispenser. Instead in these embodiments, the floss may simply be on a spool or in a ball. In another embodiment, the floss may be provided to the user in pre-cut strips.

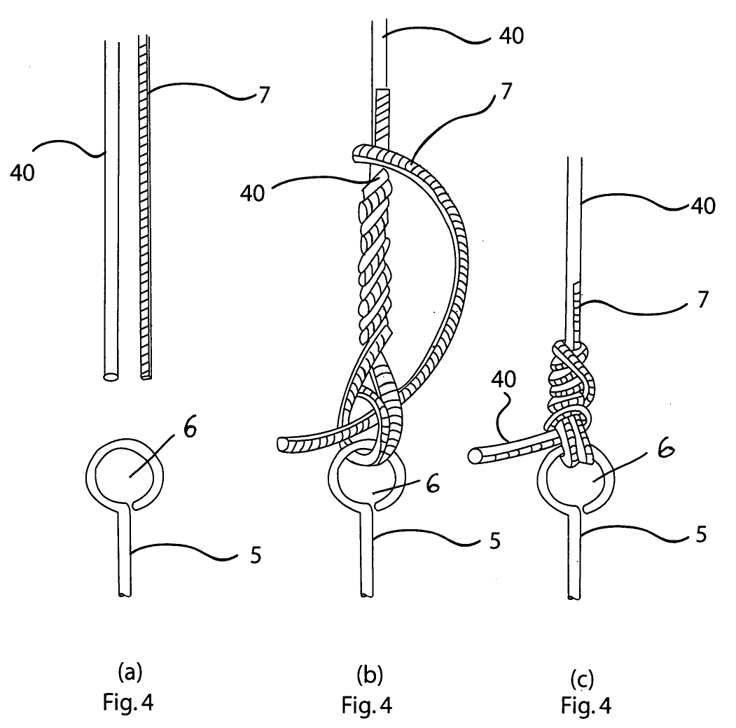

FIGS. 4(a), 4(b), and 4(c) are front views of exemplary stages of tying a knot in a fishing line 40 with floss 7, in accordance with an embodiment of the present invention. FIG. 4(a) illustrates fishing line 40 along with floss 7 positioned parallel to each other. In this stage, fishing line 40 and floss 7 are to stick together in parallel position as one unit to create a slip-free-knot to hook eye 6 of hook 5. As shown by way of example in the figures, floss 7 is only needed along the portion of fishing line 40 comprising the knot. FIG. 4(b) illustrates fishing line 40 and floss 7 stuck together as one unit, which is in the middle stage of knotting onto hook eye 6. In this stage of knotting, the portion of fishing line 40 that has floss 7 applied to it is wrapped around itself and through hook eye 6 in a conventional knot. FIG. 4(c) illustrates the completed knot. In the present illustration, floss 7 not only generally prevents slipping in the knot itself, but floss 7 also reduces slipping of fishing line 40 on hook eye 6.

The knot illustrated in FIGS. 4(a), 4(b), and 4(c) is an example to illustrate the use of floss 7, and those skilled in the art, in light of the present teachings, will recognize that a variety of knot types may be created using floss 7. It should also be appreciated that the conventional hook 5 and fishing line 40 are completely exemplary, and those skilled in the art will readily recognize how to apply the teachings of the present invention to properly adapt any suitable hook and fishing line accordingly, including, but not limited to, lures, fishing jigs, swivels, and fly fishing hooks.

In an alternate embodiment, an adhesive material without floss may be applied directly to the fishing line to generally create a laminated fish line end for improved knotting. For example, without limitation, the adhesive may be rubbed or sprayed onto the fishing line. The adhesive material may be applied to the fishing line prior to knotting or may be applied to the completed knot.

Having fully described at least one embodiment of the present invention, other equivalent or alternative means for implementing a method and device for reducing slippage in knots in fishing line according to the present invention will be apparent to those skilled in the art. For example, without limitation, the preferred embodiment describes the floss as flat, tape floss; however, in alternate embodiments the floss may be different shapes such as, but not limited to, round floss or tubes that wrap around the fishing line. The invention has been described above by way of illustration, and the specific embodiments disclosed are not intended to limit the invention to the particular forms disclosed. The invention is thus to cover all modifications, equivalents, and alternatives falling within the spirit and scope of the following claims

What is claimed is:

1. A method of attaching a fishing line to a fishing hook and to an end of another fishing line, the method comprising steps of:
obtaining an amount of adhesive material;
applying said adhesive material to an end portion of the fishing line;
passing said end portion through a hook eye of the fishing hook and a loop of said other end of fishing line; and
knotting said end portion in a manner such that said adhesive material substantially prevents slipping in the knot and substantially reduces slipping of the fishing line on the hook eye whereby breakage of the fishing line is substantially reduced during fishing.

2. The method as recited in claim 1, wherein said adhesive material comprises a floss material coated with an adhesive.

3. The method as recited in claim 2, wherein said step of obtaining further comprises the step of dispensing a portion of said floss material from a container.

4. The method as recited in claim 3, wherein said step of obtaining further comprises steps for cutting said portion.

5. The method as recited in claim 2, wherein said step of applying further comprises the step of orienting said portion of floss material parallel to said end portion of the fishing line.

6. The method as recited in claim 5, wherein said step of applying further comprises the step of wrapping said floss material about said end portion.

7. The method as recited in claim 1, wherein said step of applying further comprises the step of rubbing said adhesive material onto said end portion.

8. The method as recited in claim 1, wherein said step of applying further comprises the step of spraying said adhesive material onto said end portion.

9. An apparatus for making a fishing line knot, the apparatus comprising:
a quantity of floss material coated with an adhesive; and
dispensing means for dispensing a portion of floss material to be placed on an end portion of the fishing line where said floss material substantially prevents slipping in the knot.

10. The apparatus as recited in claim 9, wherein said dispensing means further comprises means for cutting said portion of floss material from said quantity of floss material.

11. The apparatus as recited in claim 9, wherein said floss is waxed.

12. The apparatus as recited in claim 9, wherein said floss material is configured to have sufficient surface area and texture to adequately stick to said fishing line.

13. The apparatus as recited in claim 12, wherein a width of said floss material is less than a circumference of the fishing line.

14. The apparatus as recited in claim 12, wherein said floss material is coated with said adhesive on a side.

15. The apparatus as recited in claim 9, wherein said floss material comprises any combination of natural thread silk material, cotton, yarn, rubber, artificial thread materials, nylon, or plastic.

16. The apparatus as recited in claim 9, wherein said floss material is colored to match a color of a fly or lure.

17. The apparatus as recited in claim 9, wherein said floss material is coated with a fish fragrance to enhance a lure being used.

18. An apparatus for making a fishing line knot, the apparatus comprising:
means for providing an adhesive that is suitable to be placed on an end portion of the fishing line; and
means for dispensing a portion of said adhesive to be placed on an end portion of the fishing line where said adhesive substantially prevents slipping in the knot.

19. The apparatus as recited in claim 18, further comprising means for providing a fish fragrance to said adhesive means.

20. The apparatus as recited in claim 18, further comprising means for providing a coloring to said adhesive means.
